(19) United States
(12) Patent Application Publication
(10) Pub. No.: US 2010/0206885 A1
(43) Pub. Date: Aug. 19, 2010

(54) Eating Utensil

(76) Inventors: James R. Bowden, North Scituate, RI (US); Richard A. Lucarotti, Lawrence, MA (US)

Correspondence Address: Partridge Snow & Hahn, LLP, 180 South Main St., Providence, RI, 02903, US

(21) Appl. No.: 12/708,934

(22) Filed: Feb. 19, 2010

Related U.S. Application Data
(60) Provisional application No. 61/208,038, filed on Feb. 19, 2009.

(51) Int. Cl. A47G 19/02; A47J 43/28

(52) U.S. Cl. 220/574.1; 30/327

(57) ABSTRACT

This invention is directed to a handle, wherein the handle comprises a stem portion, a u-shaped-fork at one end and a lip support attached at the u-shaped fork; and a pouch, wherein the pouch is attached about the handle at the stem, u-shaped fork and the lip support. This invention is further directed to a pouch for use in an eating utensil, wherein the pouch has means for attaching about an eating utensil, wherein the pouch is made of a material capable of absorbing energy associated with a hand or arm tremor and wherein the pouch has a bowl-like shape to store food contents.

### CROSS REFERENCE TO RELATED APPLICATION

This application claims the benefit of the filing date and incorporates in its entirety U.S. Provisional Patent Application No. 61/208,038.

### FIELD OF THE INVENTION

This invention generally relates to the field of eating utensils, and more specifically, to a spoon for use by individuals with hand or arm tremors or similar disabilities.

### BACKGROUND OF THE INVENTION

Spoons and similar utensils function primarily to transfer food into an individual's mouth. Spoons all generally have a handle portion for holding the spoon and a bowl portion for holding food. The food can generally either be liquid, soft or hard, and can be hot or cold. The spoon must be able to pick up the food, and retain the food until the spoon enters an individual's mouth. Once the spoon has entered one's mouth, it should not be difficult for an individual to remove the food from within the bowl of the spoon

This action is very difficult for individuals with arm or hand tremors. These individuals have difficulty eating without spilling their food. This situation is frustrating for the individual. It can be embarrassing, resulting in the individual not eating in public, and even further, not socializing. It can also decrease nutrition by severely limiting the type of food the individual can eat and the individual's desire to eat certain foods. Conservative estimates put the number of people afflicted with tremor from Essential Tremor, Parkinson's Disease and other similar afflictions at 4 million.

Prior art has primarily only focused on changing the shape of the bowl or handle. The prior art focuses primarily on babies, children and individuals with disabilities pertaining to their ability to physically pick up and hold the spoon. The prior art does not address the unique situation of holding food contents due to tremor. The food contents will still spill or come out of the prior art due to tremor.

What is needed is a spoon that can retain food in its bowl portion during the transfer process, but still allows for easy removal of the food contents while inside an individual's mouth. What is further needed is a spoon that can absorb the vibration and shaking that arises from hand and arm tremors to minimize spillage.

### SUMMARY OF THE INVENTION

Embodiments of the invention are concerned with an eating utensil, specifically a spoon. The spoon can specifically be used by individuals with hand or arm tremors. This invention describes a spoon that can retain food in its bowl portion during the transfer process, but still allows for easy removal of the food contents while inside an individual's mouth. This invention describes a spoon that can absorb the vibration and shaking that arises from hand and arm tremors to minimize spillage.

In an embodiment of the present invention, the spoon comprises a handle portion and a pouch portion. The pouch portion is formed around the edge of the handle portion. The handle portion extends into the portion where food contents are held. The pouch portion is deeper to help minimize food spillage. The edges of the pouch and handle portion can be raised, rounded or tapered down to make it easier to pick up food. The lipped edges also help to retain liquid contents. The pouch is also made up of a flexible material that can move independent from the handle of the spoon and help to decrease the effect of hand or arm tremor. The material is such that it can be manipulated while within an individual's mouth to easily remove the contents of the spoon.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1. illustrates a perspective view of the spoon.

FIG. 2. illustrates a top view of the handle of the spoon.

FIG. 3. illustrates a side view of the pouch.

FIGS. 4a-4c are cross section views of the spoon.

FIGS. 5a-5b are a representative depiction of the pouch during a single tremor.

### DETAILED DESCRIPTION

The present invention is concerned with an eating utensil, specifically a spoon. The spoon can specifically be used by individuals with hand or arm tremors. This invention describes a spoon that can retain food in its bowl portion during the transfer process, but still allows for easy removal of the food contents while inside an individual's mouth. This invention describes a spoon that can absorb the vibration and shaking that arises from hand and arm tremors to minimize spillage.

In the following description specific details are set forth in order to provide a thorough understanding of the present invention. However, persons having ordinary skill in the relevant arts will appreciate that these specific details may not be needed to practice the present invention.

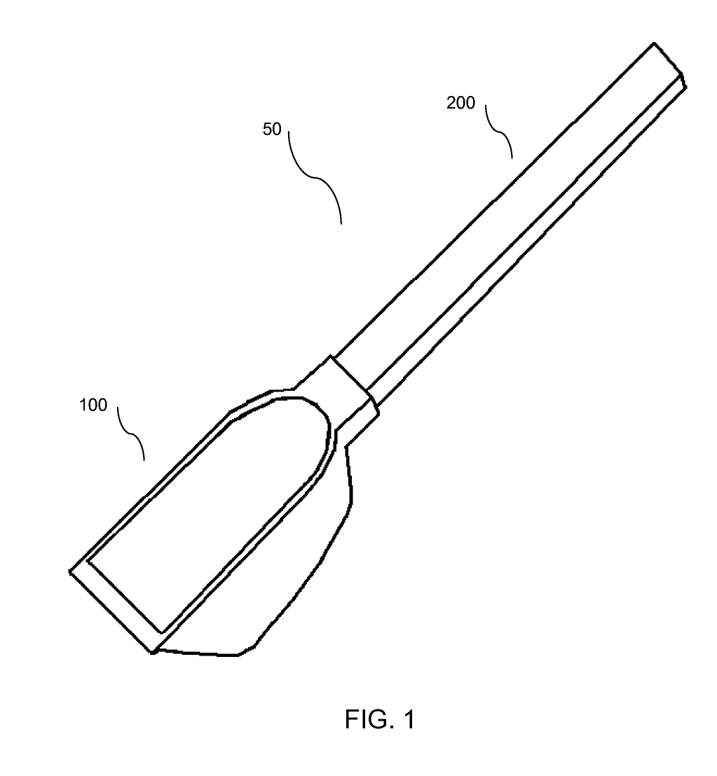

FIG. 1 is a perspective view of a preferred embodiment of the invention. It shows a spoon 50 comprised of a handle 200 and a pouch 100. The pouch 100 is formed about the handle 200, as described below.

When used with any type of food, the spoon 50 can be used in the same manner as an ordinary flatware spoon. The spoon 50 can be used with hot or cold food, which is liquid, gelatinous or small solid pieces. The spoon 50 can be held in whatever standard manner the individual chooses. In use, the individual will approach the food while holding the spoon 50 in a slight angle. Once the food is reached, the individual will either make a scooping motion or horizontal motion to place the food within the pouch 100. Once the food is inside the pouch 100, the individual will bring the spoon 50 in to a more horizontal position and lift it towards the mouth. An individual can use the spoon 50 to feed himself or another person. Even if the individual experiences a tremor, or other motion causing a sudden, slight change of direction and acceleration in the x, y or z direction, most of the food will be retained in the pouch 100 of the spoon 50.

The contents of the pouch 100 can be emptied in the individual's mouth. This can be done by turning the spoon about its axis so that the contents simply fall in to the mouth. In the alternative, the individual can use their lips, tongue and/or teeth to manipulate the pouch 100 to empty the food contents. In an embodiment of the invention, the spoon 50 will be moved past the individual's lips and teeth and into the mouth cavity. The individual's lips can then close around the spoon 50. The individual's tongue can push the bottom of the pouch 100 upward, deforming it and lifting the contents of the food out of the spoon 50. As the spoon 50 is withdrawn from the mouth, the individual's teeth and lips will remove and scrape the food contents from the spoon 50 and pouch 100. The pouch 100 will return from its deformed shape to its original shape when the spoon 50 is completely withdrawn from the mouth.

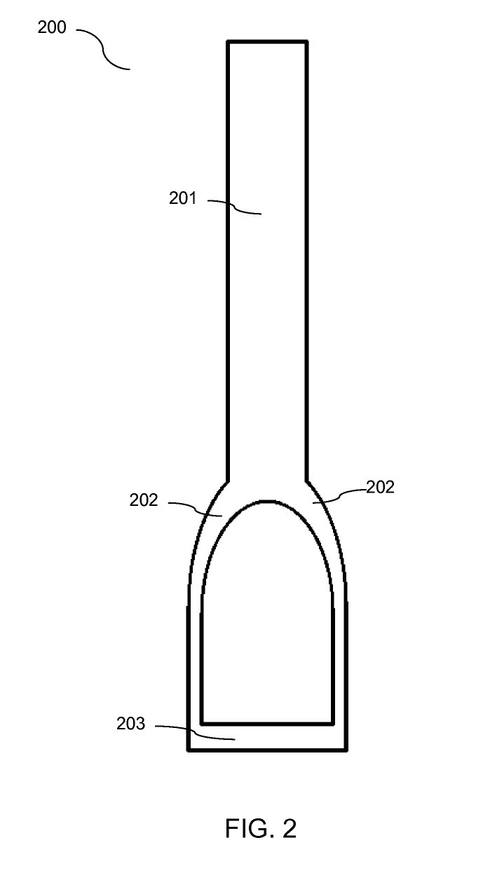

FIG. 2 is a top view of the handle 200, without the pouch 100. The handle 200 extends to the pouch or bowl section of the spoon 50. The handle 200 can be made of a stiff, food grade plastic, metal or other material commonly used in utensils. The handle comprises a stem 201, a U-shaped fork 202 and a lip support 203. The stem 201 can be similar in shape and dimensions to a standard spoon or fork. In an embodiment of the invention, the stem 201 is enlarged to allow for a better, more secure grip. In another embodiment of the invention, the enlarged grip of the stem 201 can be indented for fingers or may be weighted for balance purposes. In another embodiment the end of the stem 201 will bend downward just before the U-shaped fork 202, to increase and improve scooping and lifting ability. The U-shaped fork 202 extends from the stem 201 into the bowl portion of the spoon. The length, width and thickness of the U-shaped fork 202 should be that of a standard spoon for eating. The dimensions can be smaller if the spoon 50 is to be used for a baby, child or someone who is prone to choking. In a preferred embodiment of the invention, the length of the U-shape fork 202 will extend 1½″ from the end of the stem 201 and will be 1½″ wide at the end of the U-shaped fork 202, and the thickness of the U-shaped fork 202 will be approximately ⅛″.

The lip support 203 joins the ends of the U-shaped fork 202. The lip support 203 is of a shape to better enable the scooping action of the spoon 50. The lip support 203 can be made to be longer, thicker, tapered or sloped downward. In an embodiment of the invention, the lip support 203 is placed approximately ⅛″ below the plane of the U-shaped fork 202. Different shapes and dimensions are preferable depending on the type of food the individual is eating and one's eating style. In an embodiment of the invention, the lip support 203 begins at the same thickness as the U-shaped fork 202 and tapers to be thinner towards the end of the spoon 50. In another embodiment of the invention, the lip support 203 can be formed in to tines. In another embodiment of the invention, the attachment point between the lip support 203 and the U-shaped fork 202 can be rounded to allow for easier food pick up.

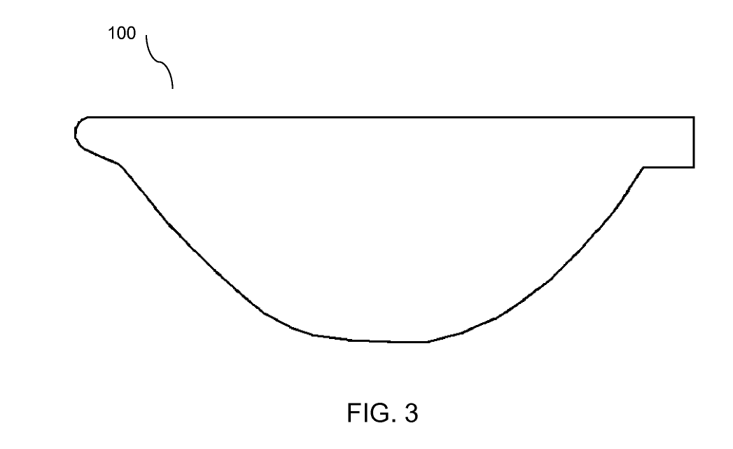

FIG. 3 is a side view of the pouch 100. The pouch 100 can be made of an elastic or flexible material that tends to return to its original shape. The material should be food grade, so that it is suitable for eating and capable of holding hot or cold food contents. In an embodiment of the invention the hardness of the pouch material should be between Shore 25A and 90A. In an embodiment of the invention, the hardness of the pouch material can be harder and stiffer in the area surrounding the lip support 203. In an embodiment of the invention the pouch material will change color as the spoon 50 is flexed or washed over time; this color code will indicate it is time to dispose of the spoon 50.

The pouch 100 is formed about the U-shaped fork 202 and lip support 203 of the handle 200. The pouch 100 extends slightly on to the stem 201 of the handle 200, for increased positioning and a secure hold. The top of the pouch 100 should generally retain the shape and dimensions of the U-shaped fork 202 and lip support 203. The pouch 100 can be formed about the handle 200 to create a more rounded edge. This will help keep foods, especially liquids, inside the spoon 50. In another embodiment of the invention, the pouch 100 is formed about the handle 200 to have a slightly raised edge. This will help keep foods inside the spoon 50. In another embodiment of the invention, the outside edge of the lip support 203 can be left uncovered to help improve the spoon's 50 ability to cut soft food and scoop foods.

The pouch 100 should be in the general shape of a bowl and should be of a sufficient depth to securely hold food and allow for some minimal tremor or shaking. In an embodiment of the invention, the depth of the pouch 100 extends downward 1″-1½″ from the U-shaped fork 202. In an embodiment of the invention, the thickness of the pouch is 1/32″. In another embodiment of the invention, the thickness of the pouch 100 does not need to be uniform throughout the pouch, but can be varied to increase the ease with which the food is place on or is removed from the spoon 50. For example, a bulge can be added to the side-walls of the pouch 100.

In an embodiment of the invention the pouch 100, U-shaped fork 202 and lip support 203 can form a single bowl and can be attached to a variety of different handles, including bendable handles, handles with swivel motions, handles and utensils that are designed to always be parallel to the ground, handles that are angled relative to the bowl and robotic or electronically controlled feeding devices. The pouch 100 can be attached to the U-shaped fork 202 and lip support 203 by molding, clamps or other adhesive method.

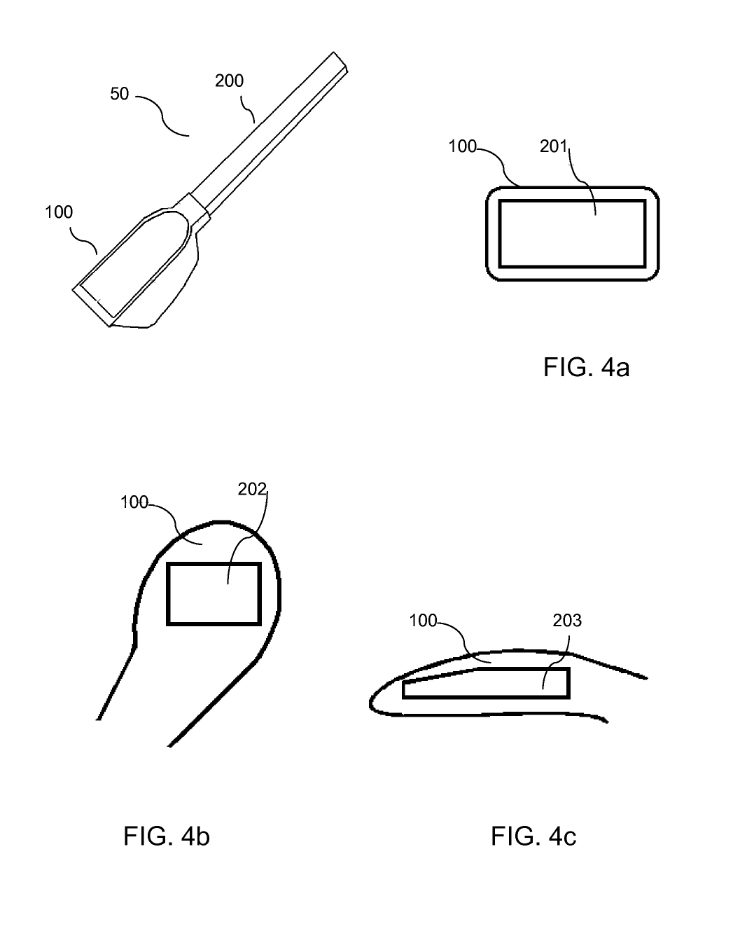

FIGS. 4a, 4b and 4b show cross-sections of the spoon at the base of the stem 201, where the pouch 100 is attached, at the U-shaped fork 202 and at the lip support 203 respectively. In this embodiment, the lip support 203 is tapered downward. As can be seen, the pouch 100 is formed about the handle 200.

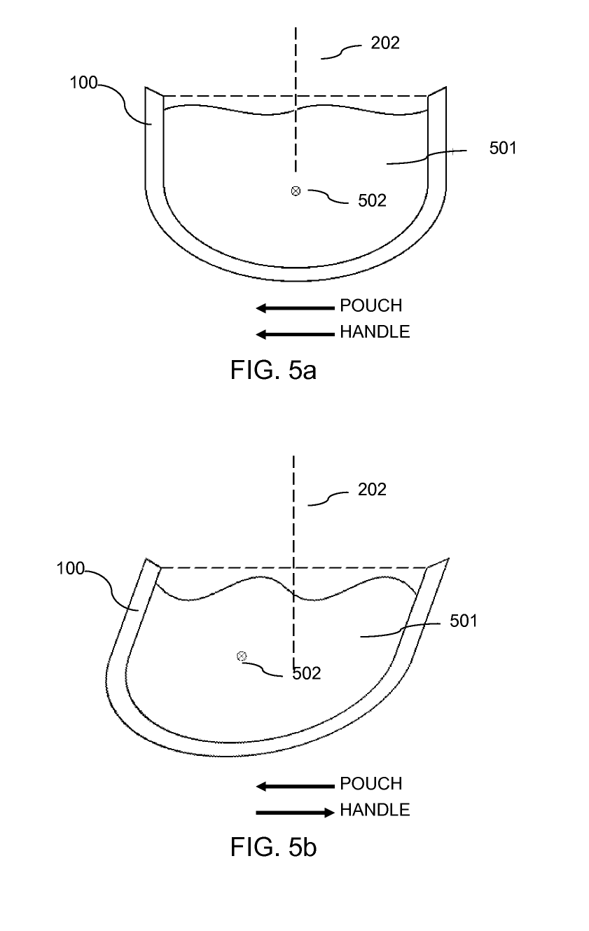

FIGS. 5a and 5b depict the motion of the pouch 100, relative to the handle 200 in a typical tremor. FIG. 5a shows the pouch 100 in its resting position, filled with food contents 501. The center mark is the center of gravity for the contents 502. The pouch 100 is able to absorb some of the energy of the tremor. The depth of the pouch 100 allows for some change in height of the food contents 501, making spillage less likely.

Tremor is a rhythmic, muscle movement involving to-and-fro movements (oscillations). For purposes of this description and the figures, assume a tremor moves in the x-direction relative to the orientation of the figure. Also assume the tremor is of equal force in both directions. This means that acceleration time will equal the deceleration time and each will be equal to one half the time it takes to go from one extreme side of the tremor's movement to the other extreme side. At the extreme sides of the tremor's movement, the direction is reversed. At the instant the direction reverses, the speed will be zero.

Once again, FIG. 5a shows the pouch 100 in its resting position. Assume the spoon 50 begins to move in the −x direction. (The arrows in the figures depict the direction of the pouch and handle.) As the spoon reaches the end of the tremor movement, the acceleration will approach zero. When the direction of the handle 200 is reversed and is about to move in the +x direction, the pouch 100, which is flexible and/or elastic, continues to move in the −x direction flexing the pouch 100. As the spoon handle 200 is about to move in the +x direction, the pouch is continuing to move in the −x direction, flexing the pouch 100 (FIG. 5b). The center of gravity will move in the −x direction as well. The stretching of the pouch converts the kinetic energy created by the motion of the tremor, to potential energy stored in the flexed and stretched bowl. Note the stretching of the bowl also helps to keep the food below the rim of the spoon, by lowering the center of gravity, thus helping to prevent spillage. The pouch 100 will continue to stretch in the −x direction until the elastic forces equal the inertial forces of the load. Once that happens, the pouch speed equals zero and the pouch 100 reverses direction to follow the handle toward the +x direction.

At this time, the pouch 100 is moving in the same direction as the handle 200. The pouch 100 is now retracting and converting the potential energy into kinetic energy. Therefore, the pouch 100 is accelerating faster than the handle 200, such that it will catch up with the handle 200. While the pouch 100 is catching up with the handle 200, the tremor energy is being absorbed. The energy absorption helps to keep the food contents within the pouch. Once the pouch 100 catches up with the handle 200, the plane of the centerline of the pouch 100 is once again lined up with the center line of the handle 200 and the speed of the pouch 100 and handle 200 will be the same. The process will repeat itself for the duration of the tremor.

In an embodiment of the invention, an additional shock absorbing material can be added at the base of the stem 201, where the pouch 100 is located, to further reduce spilling.

It is to be understood that modifications and variations of the invention described herein may be apparent to one skilled in the art and this description shall not limit such modifications and variations.

What is claimed is:

1. A spoon comprising:
a handle, wherein the handle comprises a stem portion, a u-shaped-fork at one end and a lip support attached at the u-shaped fork; and
a pouch, wherein the pouch is attached about the handle at the stem, u-shaped fork and the lip support.

2. The spoon of claim 1, wherein the pouch is made of a flexible material capable of absorbing energy associated with a hand or arm tremor.

3. The spoon of claim 1, wherein the pouch is made of an elastic material capable of absorbing energy associated with a hand or arm tremor.

4. The spoon of claim 1, wherein the pouch has edges that are rounded.

5. The spoon of claim 1, wherein the pouch has edges that are raised above the u-shaped fork.

6. The spoon of claim 1, wherein the lip support further comprises tines extending in the direction away from the handle.

7. The spoon of claim 1, wherein the lip support is similar in thickness to the u-shaped fork and tapers downward to allow for easier pick up of food.

8. The spoon of claim 1, wherein the stem of the handle is sloped downward at its base towards the pouch such that the overall pouch portion of the spoon is angled below the handle.

9. The spoon of claim 1, wherein the pouch can be pushed upwards by a person's tongue to remove any food contents

10. The spoon of claim 1, wherein the pouch is made of a material with a hardness between Shore 25A and 90A.

11. The spoon of claim 1, wherein the pouch is harder and stiffer in the area surrounding the lip support.

12. The spoon of claim 1, wherein a portion of the lip support extends beyond the pouch.

13. The spoon of claim 1, wherein the depth of the pouch is between 1″ and 1½″.

14. The spoon of claim 1, wherein the thickness of the pouch is uniform throughout the pouch and is approximately 1/32″.

15. A bowl for use in an eating utensil, wherein the bowl has means for attaching about an eating utensil comprising:
u-shaped fork, for supporting and holding the shape of the bowl;
a lip support, for creating a scooping edge at the end of the bowl, wherein the lip support is positioned between and at the opening of the u-shaped fork; and
a pouch, wherein the pouch is formed about the u-shaped fork and the lip support and wherein the pouch is made of a material capable of absorbing energy associated with a hand or arm tremor.

16. The bowl of claim 15, wherein the depth of the pouch is 1″ to 1½″.

17. The bowl of claim 15, wherein the thickness of the pouch is uniform throughout the pouch and is approximately 1/32″.

18. The bowl of claim 15, wherein the thickness is not uniform throughout the pouch.

19. A spoon for use by individuals with hand or arm tremors comprising:
a stem, for enabling the individual to hold the spoon;
a u-shaped fork, for supporting and holding the shape of the spoon, at the base of the stem;
a lip support, for creating a scooping edge at the end of the spoon, wherein the lip support is positioned between and at the opening of the u-shaped fork; and
a pouch, wherein the pouch is formed about the stem at its base, the u-shaped fork and the lip support, and wherein the pouch is made of a material capable of flexing and retracting to its original shape so that the pouch is able to move slightly independently of the stem, and u-shaped fork.
